(19) United States
(12) Patent Application Publication
(10) Pub. No.: US 2025/0165862 A1
(43) Pub. Date: May 22, 2025

(54) INFORMATION PROCESSING SYSTEM, INFORMATION PROCESSING METHOD, AND PROGRAM

(71) Applicant: Sony Interactive Entertainment Inc., Tokyo (JP)

(72) Inventors: Shogo Sato, Tokyo (JP); Tetsugo Inada, Tokyo (JP); Hiroyuki Segawa, Kanagawa (JP)

(73) Assignee: Sony Interactive Entertainment Inc., Tokyo (JP)

(21) Appl. No.: 18/841,737

(22) PCT Filed: Mar. 15, 2022
(86) PCT No.: PCT/JP2022/011645

§ 371 Date: Aug. 27, 2024

(51) Int. Cl. G06N 20/00

(52) U.S. Cl. CPC G06N 20/00

(57) ABSTRACT

The accuracy of a machine learning model is improved while the maintenance of training data is facilitated. An information processing system outputs, on the basis of an output of a machine learning model being trained with training data when input data is received to the machine learning model as an input, reliability of the output for the input data, generates new training data on the basis of the input data in a case where the reliability satisfies a predetermined condition, and trains the machine learning model with the new training data.

### TECHNICAL FIELD

The present invention relates to an information processing system, an information processing method, and a program.

### BACKGROUND ART

General machine learning models are trained with training data prepared in advance. Sida Peng et al. presented a paper “PVNet: Pixel-Wise Voting Network for 6DoF Pose Estimation” at the 2019 IEEE/CVF Conference on Computer Vision and Pattern Recognition (CVPR). This paper discloses that a machine learning model is trained with training data including input images and ground truth output images, and that, on the basis of the output when captured images are input to that machine learning model, the positions of keypoints on the images used for pose estimation are calculated.

### SUMMARY

### Technical Problem

A large amount of training data is required to train a machine learning model, but the preparation of that data is labor-intensive. Meanwhile, if the amount of training data is reduced, there is a risk that the accuracy of the machine learning model cannot be ensured.

The present invention has been made in view of the above-mentioned circumstances, and it is an object thereof to provide a technology for improving the accuracy of a machine learning model while reducing the labor required for the maintenance of training data.

### Solution to Problem

In order to solve the above-mentioned problem, an information processing system according to the present invention includes a machine learning model trained with training data, reliability output means outputting, on the basis of an output of the machine learning model when input data is received as an input, reliability of the output for the input data, generation means generating new training data on the basis of the input data in a case where the reliability satisfies a predetermined condition, and learning control means training the machine learning model with the new training data.

In one aspect of the present invention, the information processing system may further include a trained estimation model configured to output an estimation result on the basis of the output of the machine learning model, and the reliability output means may output the reliability of the output of the machine learning model for the input data on the basis of an output of the estimation model.

In one aspect of the present invention, the input data may include an image in which a target object is captured, the estimation model may output an image indicating a keypoint for pose estimation of the target object on the basis of the output of the machine learning model, and the reliability output means may output the reliability on the basis of the image.

In one aspect of the present invention, the estimation model may output an image in which each point indicates a positional relation with the keypoint, and the reliability output means may output the reliability on the basis of a variation of candidates for positions of a plurality of the keypoints each generated from points different from each other included in the image output by the estimation model.

In one aspect of the present invention, the reliability output means may output the reliability on the basis of information indicating a difference between the output of the estimation model when an input image in which the target object is captured is input to the estimation model and the output of the estimation model when a processed image obtained by processing the input image by predetermined processing is input to the estimation model.

In one aspect of the present invention, the machine learning model may output information indicating whether the input data includes the target object or not.

In one aspect of the present invention, the estimation model may be trained with estimation training data, the generation means may generate new estimation training data on the basis of the input data in a case where the reliability satisfies the predetermined condition, and the learning control means may train the machine learning model with the new training data.

In one aspect of the present invention, the input data may include an image in which a target object is captured, the machine learning model may output an image indicating a keypoint for pose estimation of the target object on the basis of the input data, and the reliability output means may output the reliability on the basis of the image.

In one aspect of the present invention, the training data may include a plurality of learning images rendered from a three-dimensional shape model and ground truth images each serving as ground truth data for a corresponding one of the learning images.

In one aspect of the present invention, the generation means may generate new training data including a first additional image obtained by processing the input data by first processing and a second additional image obtained by processing the input data by second processing different from the first processing, and the learning control means may train the machine learning model on the basis of a difference between an output when the first additional image is input to the machine learning model and an output when the second additional image is added to the machine learning model.

Further, an information processing method according to the present invention includes a step of outputting, on the basis of an output of a machine learning model being trained with training data when input data is received as an input to the machine learning model, reliability of the output for the input data, a step of generating new training data on the basis of the input data in a case where the reliability satisfies a predetermined condition, and a step of training the machine learning model with the new training data.

Further, a program according to the present invention causes a computer to execute the processing of outputting, on the basis of an output of a machine learning model being trained with training data when input data is received as an input to the machine learning model, reliability of the output for the input data, generating new training data on the basis of the input data in a case where the reliability satisfies a predetermined condition, and training the machine learning model with the new training data.

### Advantageous Effects of Invention

According to the present invention, it is possible to improve the accuracy of the machine learning model while reducing the labor required for the maintenance of the training data.

### BRIEF DESCRIPTION OF DRAWINGS

FIG. 1 is a diagram illustrating an example of a configuration of an information processing system according to one embodiment of the present invention.

FIG. 2 is a functional block diagram illustrating examples of functions implemented in the information processing system according to the embodiment of the present invention.

FIG. 3 is a view illustrating an example of an input image.

FIG. 4 is a view illustrating examples of keypoints of a target object.

FIG. 5 is a diagram schematically illustrating an example of a position image in a target region.

FIG. 6 is a flow diagram illustrating an example of processing mainly performed by a target region acquisition unit and a pose estimation unit.

FIG. 7 is a view illustrating the detected pose of the target object.

FIG. 8 is a flow diagram schematically illustrating the training of a discriminative model and an estimation model.

FIG. 9 is a flow diagram illustrating an example of the processing of generating initial training data.

FIG. 10 is a view illustrating how the target object is captured.

FIG. 11 is a flow diagram illustrating an example of the processing of retraining the estimation model.

### DESCRIPTION OF EMBODIMENTS

Now, one embodiment of the present invention is described in detail on the basis of the drawings. In the present embodiment, a description is given on a case where the invention is applied to an information processing system configured to receive as an input an image in which an object is captured and estimate a pose of the object.

This information processing system includes a machine learning model configured to determine whether at least a part of a captured image includes an object or not, and a machine learning model configured to output information indicating an estimated pose of that object from the image including the object. Further, the information processing system is configured to complete the training of the machine learning models in a short period of time. The required time is assumed to be, for example, several tens of seconds to grasp and rotate the object, and approximately a few minutes for machine learning.

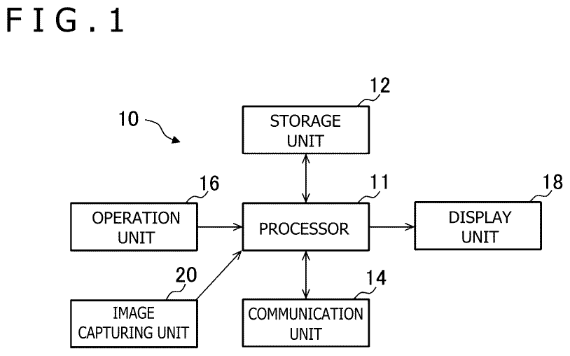

FIG. 1 is a diagram illustrating an example of the configuration of the information processing system according to the embodiment of the present invention. The information processing system according to the present embodiment includes an information processing apparatus 10. The information processing apparatus 10 is, for example, a computer such as a game console or a personal computer. As illustrated in FIG. 1, the information processing apparatus 10 includes, for example, a processor 11, a storage unit 12, a communication unit 14, an operation unit 16, a display unit 18, and an image capturing unit 20. The information processing system may include the single information processing apparatus 10, or may include a plurality of apparatuses including the information processing apparatus 10.

The processor 11 is a program-controlled device such as a CPU (Central Processing Unit), configured to operate in accordance with programs installed in the information processing apparatus 10, for example.

The storage unit 12 includes at least some of storage elements such as a ROM (Read-Only Memory) and a RAM (Random Access Memory) and external storage apparatuses such as solid-state drives. The storage unit 12 stores programs and the like that are executed by the processor 11.

The communication unit 14 is a communication interface for wired communication or wireless communication, such as a network interface card, and exchanges data with other computers and terminals via a computer network such as the Internet.

The operation unit 16 is, for example, an input device such as a keyboard, a mouse, a touch panel, or a game console controller, and receives user's operation input and outputs a signal indicating the content thereof to the processor 11.

The display unit 18 is a display device such as a liquid crystal display and displays various images in accordance with instructions from the processor 11. The display unit 18 may be a device configured to output video signals to external display devices.

The image capturing unit 20 is an image capturing device such as a digital camera. The image capturing unit 20 according to the present embodiment is a camera capable of capturing moving images, for example. The image capturing unit 20 may be a camera capable of acquiring visible RGB images. The image capturing unit 20 may be a camera capable of acquiring visible RGB images and depth information synchronized with those RGB images. The image capturing unit 20 may be external to the information processing apparatus 10, and in this case, the information processing apparatus 10 may be connected to the image capturing unit 20 via the communication unit 14 or an input/output unit described later.

Note that the information processing apparatus 10 may include an audio input/output device such as a microphone or a speaker. Further, the information processing apparatus 10 may include, for example, a communication interface such as a network board, an optical disc drive configured to read optical discs such as DVD (Digital Versatile Disc)-ROM and Blu-ray (registered trademark) discs, or the input/output unit (USB (Universal Serial Bus) port) for data input/output to/from external equipment.

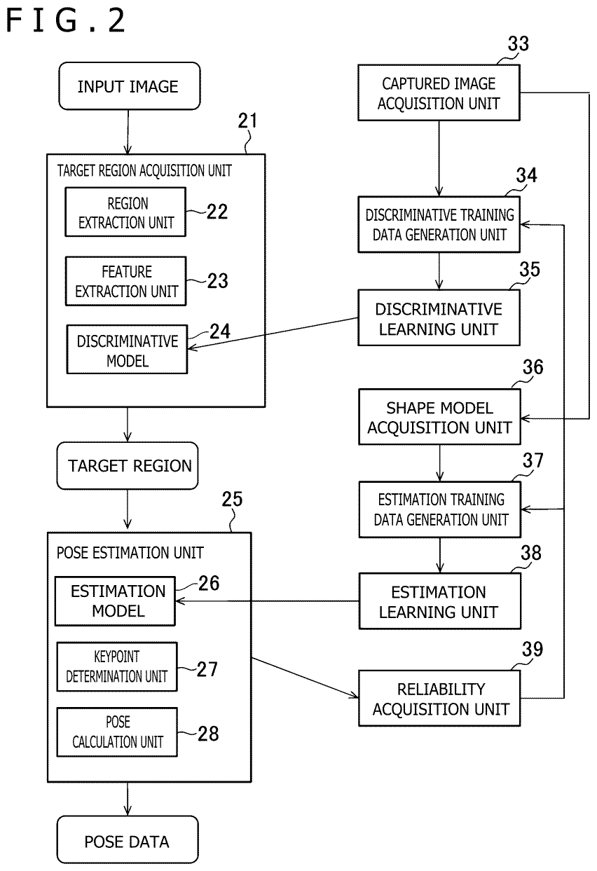

FIG. 2 is a functional block diagram illustrating examples of functions implemented in the information processing system according to the embodiment of the present invention. As illustrated in FIG. 2, the information processing system functionally includes a target region acquisition unit 21, a pose estimation unit 25, a captured image acquisition unit 33, a discriminative training data generation unit 34, a discriminative learning unit 35, a shape model acquisition unit 36, an estimation training data generation unit 37, an estimation learning unit 38, and a reliability acquisition unit 39. The target region acquisition unit 21 functionally includes a region extraction unit 22, a feature extraction unit 23, and a discriminative model 24. The pose estimation unit 25 functionally includes an estimation model 26, a keypoint determination unit 27, and a pose calculation unit 28. The discriminative model 24 and the estimation model 26 are both types of machine learning models.

These functions are implemented mainly by the processor 11 and the storage unit 12. More specifically, these functions may be implemented by the processor 11 executing a program installed in the information processing apparatus 10 which is a computer and including execution commands corresponding to the functions described above. Further, for example, this program may be supplied to the information processing apparatus 10 via a computer-readable information storage medium such as an optical disc, a magnetic disk, or flash memory, or via the Internet or the like.

Note that, in the information processing system according to the present embodiment, all the functions illustrated in FIG. 2 are not necessarily implemented, and functions other than the functions illustrated in FIG. 2 may be implemented.

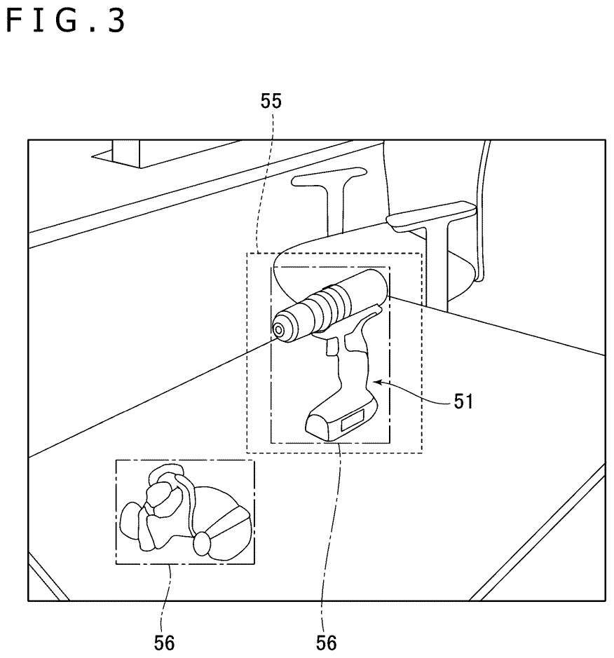

The target region acquisition unit 21 acquires an input image captured by the image capturing unit 20 and determines whether each of one or multiple candidate regions 56 (see FIG. 3) included in that acquired input image includes the image of a target object 51 or not. The region extraction unit 22 extracts the one or multiple candidate regions 56, and the feature extraction unit 23 extracts feature amounts indicating the features of images from each of the candidate regions 56. The discriminative model 24 receives as inputs those feature amounts as the images of those candidate regions 56 and outputs information indicating whether those candidate regions 56 include the image of the target object 51 or not.

The target region acquisition unit 21 acquires, in a case where the candidate region 56 includes the target object 51, a target region 55 including the image of the target object 51 and extracted from the input image. The target object 51 is an object, the pose of which is to be estimated in the information processing apparatus 10. The target object 51 is a subject of prior training.

FIG. 3 is a view illustrating an example of the input image. In the example of FIG. 3, the target object 51 is a power tool, and also in the subsequent figures, unless otherwise specified, an example of the target object 51 is assumed to be a power tool. The input image is captured by the image capturing unit 20, and the target region 55 is a rectangular region including the target object 51 and the vicinity thereof. Note that, in the process of acquiring the target region 55, the one or multiple candidate regions 56 including regions not including the target object 51 are also extracted as candidates for regions including the target object 51.

The region extraction unit 22 extracts, from the input image, the images of the candidate regions 56 to be determined by the discriminative model 24. More specifically, the region extraction unit 22 discriminates the one or multiple candidate regions 56 in which some object is captured from the input image by a well-known Region Proposal technology and extracts each of that one or multiple candidate regions 56.

The discriminative model 24 is a machine learning model and trained with training data. When receiving input data as an input, the trained discriminative model 24 outputs data as a result of discrimination. The input data input to the discriminative model 24 is information indicating the images of the candidate regions 56 and includes, for example, feature amounts extracted from those images by the feature extraction unit 23. Further, when receiving input data as an input, the discriminative model 24 outputs information indicating whether the images of those candidate regions 56 include the image of the target object 51 or not.

The training data for the discriminative model 24 includes data indicating each of learning images including a plurality of positive example images including an image in which the target object 51 is captured and a plurality of negative example images not including the target object 51. The details of the discriminative model 24 and the training thereof are described later. Each learning image may be the image of a region in which the target object 51 is present in the captured image. That region may be extracted by a similar method to the region extraction unit 22. Note that the discriminative model 24 is trained not only with the training data described above but also with additional training data.

Note that the images of the candidate regions 56 may be directly input to the discriminative model 24 without intermediation of the feature extraction unit 23. Although there is a risk of a decrease in accuracy, the region extraction unit 22 may not be provided. In this case, the feature extraction unit 23 may extract features from the input image itself, and the discriminative model 24 may determine whether the target object 51 is present in that input image, or the input image may be directly input to the discriminative model 24.

The pose estimation unit 25 estimates the pose of the target object 51 on the basis of information output when the target region 55 is input to the estimation model 26. The estimation model 26 is a machine learning model and trained with training data. When receiving input data as an input, the trained estimation model 26 outputs data as an estimation result. The training data includes a plurality of learning images rendered by a three-dimensional shape model of the target object 51 and ground truth data that is information regarding the pose of the target object 51 in those learning images.

The trained estimation model 26 receives as an input information indicating the image of the target region 55, and the estimation model 26 outputs information indicating the positions of keypoints for pose estimation of the target object. The target region 55 is an image based on the candidate region 56 selected on the basis of the output of the discriminative model 24. The training data for the estimation model 26 includes a plurality of learning images rendered by the three-dimensional shape model of the target object 51, and ground truth data indicating the positions of the keypoints of the target object 51 in the learning images. The keypoints are virtual points within the target object 51 that are used for the calculation of the pose. Note that the estimation model 26 is trained not only with the training data described above but also with additional training data. The additional training data includes images generated on the basis of the input image, and whether or not to add training data on the basis of the input image is determined on the basis of the output of the estimation model 26.

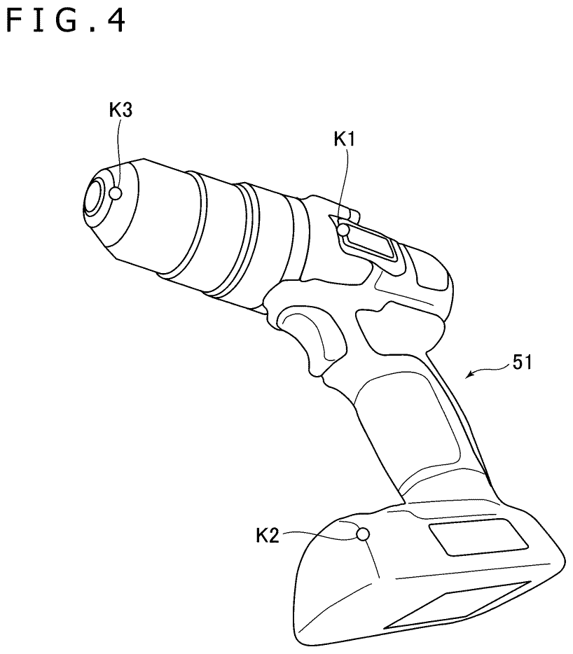

FIG. 4 is a view illustrating examples of the keypoints of the target object 51. The three-dimensional positions of the keypoints of the target object 51 are determined from the three-dimensional shape model of the target object 51 (more specifically, information regarding vertices included in the three-dimensional shape model) by a well-known Farthest Point algorithm, for example. In FIG. 4, for ease of description, three keypoints K1 to K3 are illustrated, but the actual number of keypoints may be larger. For example, in the present embodiment, the actual number of keypoints of the target object 51 is eight.

When receiving the target region 55 as an input, the trained estimation model 26 outputs information indicating the two-dimensional positions of the keypoints of the target object 51 in the target region 55. From the two-dimensional positions of the keypoints in the target region 55 and the position of the target region 55 in the input image, the two-dimensional positions of the keypoints in the input image are obtained. Data indicating the positions of the keypoints may be a position image in which each point indicates the positional relation (for example, a direction) between that point and the keypoint.

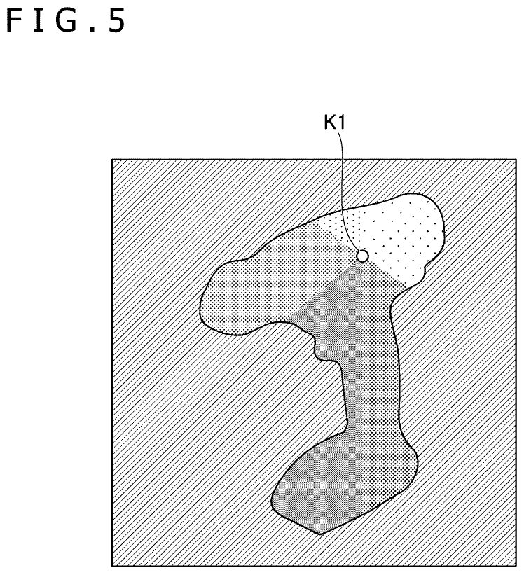

FIG. 5 is a diagram schematically illustrating an example of the position image in the target region 55. The position image may be generated for each type of keypoint. The position image indicates the relative direction at each point between that point and the keypoint. In the position image illustrated in FIG. 5, a pattern corresponding to the value of each point is illustrated, and the value of each point indicates the direction between the coordinates of that point and the coordinates of the keypoint. FIG. 5 is merely a schematic diagram, and the actual values of each point change continuously. Although not explicitly illustrated in FIG. 5, the position image is a Vector Field image indicating the relative direction of the keypoint at each point with that point used as a reference.

The keypoint determination unit 27 determines the two-dimensional positions of the keypoints in the target region 55 and the input image on the basis of the output of the estimation model 26. More specifically, for example, the keypoint determination unit 27 calculates candidates for the two-dimensional positions of the keypoints in the target region 55 on the basis of the position image output from the estimation model 26 and determines the two-dimensional positions of the keypoints in the input image from the calculated candidates for the two-dimensional positions. For example, the keypoint determination unit 27 calculates candidate points for the keypoint from each combination of any two points in the position image and generates a score indicating whether the direction indicated by each point in the position image matches the plurality of candidate points. The keypoint determination unit 27 may estimate the candidate point with the highest score as the position of the keypoint. Further, the keypoint determination unit 27 repeats the processing described above for each keypoint.

The pose calculation unit 28 estimates the pose of the target object 51 on the basis of information indicating the two-dimensional positions of the keypoints in the input image and information indicating the three-dimensional positions of the keypoints in the three-dimensional shape model of the target object 51 and outputs pose data indicating the estimated pose. The pose of the target object 51 is estimated by a well-known algorithm. For example, the pose may be estimated by solving a Perspective-n-Point (PnP) problem for pose estimation (for example, EPnP). Further, the pose calculation unit 28 may estimate not only the pose of the target object 51 but also the position of the target object 51 in the input image, and the pose data may include information indicating that position.

The details of the estimation model 26, the keypoint determination unit 27, and the pose calculation unit 28 may be as described in the paper “PVNet: Pixel-Wise Voting Network for 6DoF Pose Estimation.”

The captured image acquisition unit 33, the discriminative training data generation unit 34, the discriminative learning unit 35, the shape model acquisition unit 36, the estimation training data generation unit 37, the estimation learning unit 38, and the reliability acquisition unit 39 are components related to the training of the discriminative model 24 and the estimation model. In the present embodiment, first, on the basis of the image in which the target object 51 is captured, the discriminative model 24 and the estimation model 26 are trained for, for example, a few seconds and a few minutes, respectively, which are short periods of time. After the operation of the target region acquisition unit 21 and the pose estimation unit 25 based on the discriminative model 24 and the estimation model 26, which have been trained, the discriminative model 24 and the estimation model 26 are trained again.

To train the estimation model 26 included in the pose estimation unit 25 and/or the discriminative model 24 included in the target region acquisition unit 21, the captured image acquisition unit 33 acquires a captured image in which the target object 51 is captured by the image capturing unit 20. The image capturing unit 20 is assumed to have camera internal parameters acquired by calibration in advance. These parameters are used in solving the PnP problem.

The discriminative training data generation unit 34 generates positive example training data based on images including the target object 51 and negative example training data based on images not including the target object 51. The image including the target object 51 may be acquired by the captured image acquisition unit 33.

The discriminative learning unit 35 trains the discriminative model 24 included in the target region acquisition unit 21 on the basis of training data generated by the discriminative training data generation unit 34.

The shape model acquisition unit 36 extracts a plurality of feature vectors indicating local features for each of a plurality of captured images for the target object 51 acquired by the captured image acquisition unit 33 and obtains, on the basis of the plurality of corresponding feature vectors extracted from the plurality of captured images and the positions at which those feature vectors have been extracted in the captured images, the three-dimensional positions of the points from which those feature vectors have been extracted, thereby acquiring the three-dimensional shape model of the target object 51 on the basis of those three-dimensional positions. Since this method is a well-known method also used for software for implementing what is generally called SfM (Structure from Motion) and Visual SLAM (Visual Simultaneous Localization and Mapping), the detailed description thereof is omitted.

The estimation training data generation unit 37 generates training data for training the estimation model 26. More specifically, the estimation training data generation unit 37 generates, as initial training data, training data including training images rendered from the three-dimensional shape model of the target object 51 and ground truth data indicating the positions of the keypoints.

The estimation learning unit 38 trains the estimation model 26 included in the pose estimation unit 25 with training data generated by the estimation training data generation unit 37.

The reliability acquisition unit 39 acquires, on the basis of the output of the machine learning model when receiving input data as an input, the reliability of the output of the machine learning model for that input data. Acquiring reliability on the basis of the output of the machine learning model refers to, for example, calculating reliability on the basis of the output of the discriminative model 24, which is a machine learning model, more specifically, of the result of the processing on the latter stage of the reception of that output, and to calculating reliability on the basis of a position image output by the estimation model 26.

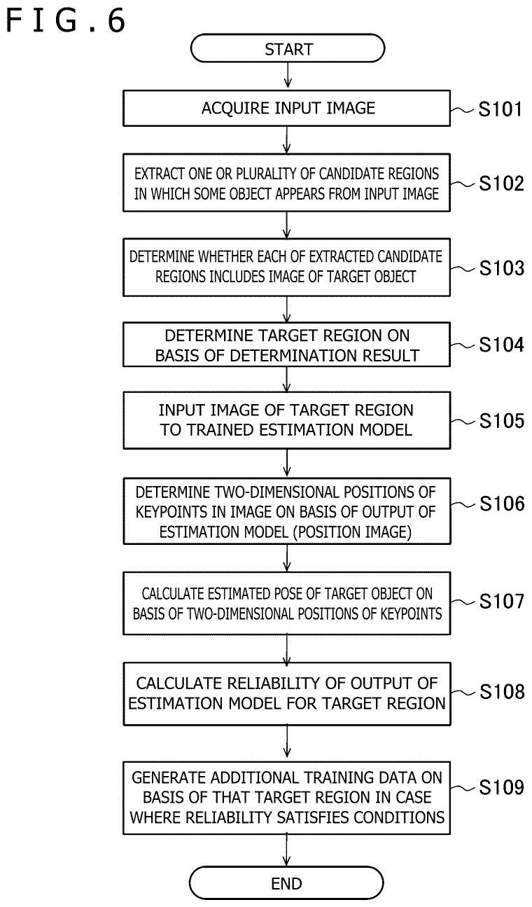

Next, the processing regarding pose estimation is described. FIG. 6 is a flow diagram illustrating an example of processing mainly performed by the target region acquisition unit 21 and the pose estimation unit 25. The processing illustrated in FIG. 6 may be periodically executed repeatedly.

First, the region extraction unit 22 included in the target region acquisition unit 21 acquires an input image captured by the image capturing unit 20 (S101). The region extraction unit 22 may acquire the input image by directly receiving the input image from the image capturing unit 20, or may acquire the input image received from the image capturing unit 20 and stored in the storage unit 12.

The region extraction unit 22 extracts the one or multiple candidate regions 56 in which some object appears from the input image (S102). The region extraction unit 22 may include an RPN (Regional Proposal Network) trained in advance. The RPN may be trained with training data unrelated to an image in which the target object 51 is captured. Through this processing, wasteful calculations are reduced, and a certain level of robustness against the environment is ensured.

Here, the region extraction unit 22 may further execute, for example, processing such as background removal processing (mask processing) or size adjustment on the images of the extracted candidate regions 56. Further, the processed images of the candidate regions 56 may be used in subsequent processing. Through this processing, the domain gap caused by background and lighting conditions is reduced, thereby making it possible to train the discriminative model 24 with less training data.

The target region acquisition unit 21 determines whether each of the candidate regions 56 includes the image of the target object 51 (S103). This processing includes the processing of extracting, by the feature extraction unit 23, feature amounts from the images of the candidate regions 56, and the processing of outputting, by the discriminative model 24, information indicating whether or not the candidate regions 56 include the target object 51, from those feature amounts.

The feature extraction unit 23 outputs, from the images of the candidate regions 56, the feature amounts corresponding to those images. The feature extraction unit 23 includes a trained CNN (Convolutional Neural Network). This CNN outputs, in response to the input of an image, feature amount data (input feature amount data) indicating a feature amount corresponding to the image in question. The feature extraction unit 23 may extract feature amounts from the images of the candidate regions 56 extracted by the RPN, or may acquire feature amounts extracted in the processing of the RPN, as in Faster R-CNN, for example.

The discriminative model 24 is an SVM (Support Vector Machine) or the like, and is a type of machine learning model. The discriminative model 24 outputs, in response to the input of input feature amount data indicating feature amounts corresponding to the images of the candidate regions 56, a discriminative score indicating the probability that the object appearing in the candidate regions 56 belongs to the positive class of the discriminative model 24. The discriminative model 24 is trained with a plurality of pieces of positive example training data on positive examples and a plurality of pieces of negative example training data on negative examples. The positive example training data is generated from learning images including images in which the target object 51 is captured, and the negative example training data is generated from images that are the images of objects different from the target object 51 prepared in advance. The negative example training data may be generated by capturing the environment of the image capturing unit 20 captured by that image capturing unit 20.

In the present embodiment, this CNN is used to generate feature amount data indicating feature amounts corresponding to images subjected to normalization processing. Note that the feature extraction unit 23 may output, in response to the input of an image, feature amount data indicating a feature amount corresponding to the image in question by other well-known algorithms for calculating feature amounts indicating the features of images.

The target region acquisition unit 21 determines, in a case where the discriminative score is greater than a threshold, for example, that the candidate region 56 includes the image of the target object 51.

When it is determined whether each of the candidate regions 56 includes the image of the target object 51, the target region acquisition unit 21 determines the target region 55 on the basis of those determination results (S104). More specifically, the target region acquisition unit 21 acquires a rectangular region including the vicinity region of the target object 51 as the target region 55 on the basis of the candidate region 56 determined to include the target object 51. The target region acquisition unit 21 may acquire a square region including the vicinity region of the target object 51 as the target region 55, or may simply acquire the candidate region 56 as the target region 55. Note that the target region acquisition unit 21 may not always acquire the target region 55 through the processing in S102 and S103. For example, the target region acquisition unit 21 may perform well-known time-series tracking processing on an input image acquired after the target region 55 has been acquired, thereby acquiring the target region 55.

The pose estimation unit 25 inputs the image of the target region 55 to the trained estimation model 26 (S105). The image of the target region 55 input here may be an image with a size adjusted (increased or decreased) to match the size of the input image of the estimation model 26. Through size adjustment (normalization), the efficiency of the training of the estimation model 26 is improved. Note that the pose estimation unit 25 may mask the background of the image of the target region 55 and input the image of the target region 55 with the background masked to the estimation model 26.

The keypoint determination unit 27 included in the pose estimation unit 25 determines the two-dimensional positions of keypoints in the target region 55 and the input image on the basis of the output of the estimation model 26 (S106). In a case where the output of the estimation model 26 is a position image, the keypoint determination unit 27 calculates candidates for the positions of the keypoints from each point in the position image and determines the positions of the keypoints on the basis of those candidates. In a case where the output of the estimation model 26 includes the positions of the keypoints in the target region 55, the positions of the keypoints in the input image may be calculated from those positions. Note that the processing in S105 and S106 is performed for each type of keypoint.

The pose calculation unit 28 included in the pose estimation unit 25 calculates the estimated pose of the target object 51 on the basis of the determined two-dimensional positions of the keypoints (S107). The pose calculation unit 28 may calculate the position of the target object 51 together with the pose. The pose and position may be calculated by solving the PNP problem described above.

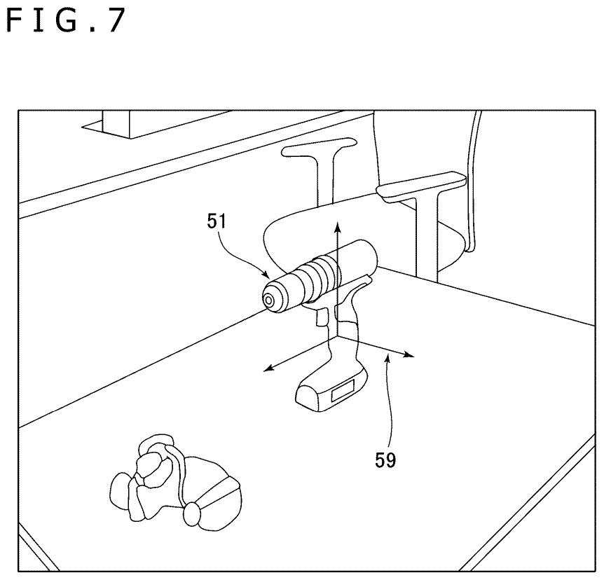

FIG. 7 is a view illustrating the detected pose of the target object 51. In FIG. 7, for ease of description, the pose of the target object 51 is represented by a local coordinate axis system 59 indicating the local coordinate system of the target object 51. The position of the origin of the local coordinate axis system 59 indicates the position of the target object 51, and the directions of the lines of the local coordinate axis system 59 indicate the pose.

Here, the reliability acquisition unit 39 calculates the reliability of the output of the estimation model 26 for the target region 55 (S108). Then, in a case where that reliability satisfies conditions defined in advance, the discriminative training data generation unit 34 and the estimation training data generation unit 37 generate additional training data for the discriminative model 24 and the estimation model 26, respectively, on the basis of that target region (S109). The processing in S109 is the processing of generating, after the training (inference) of a machine learning model, additional training data on the basis of data input to that machine learning model. The details of the processing in S108 and S109 are described later.

The estimated pose and position of the target object 51 may be utilized in various ways. For example, the pose and the position may be input to application software such as a video game instead of operation information input with a controller. Then, the processor 11 configured to execute execution codes of the application software may generate data on an image on the basis of that pose (and position) and cause the display unit 18 to output that image. Further, the processor 11 may cause the information processing apparatus 10 or an audio output apparatus connected to the information processing apparatus 10 to output sound based on that pose (and position). Further, the processor 11 may control the operation of an AI (Artificial Intelligence) agent, such as a robot, by notifying the AI agent of the position and pose of the object, thereby causing the AI agent to grasp the object, for example.

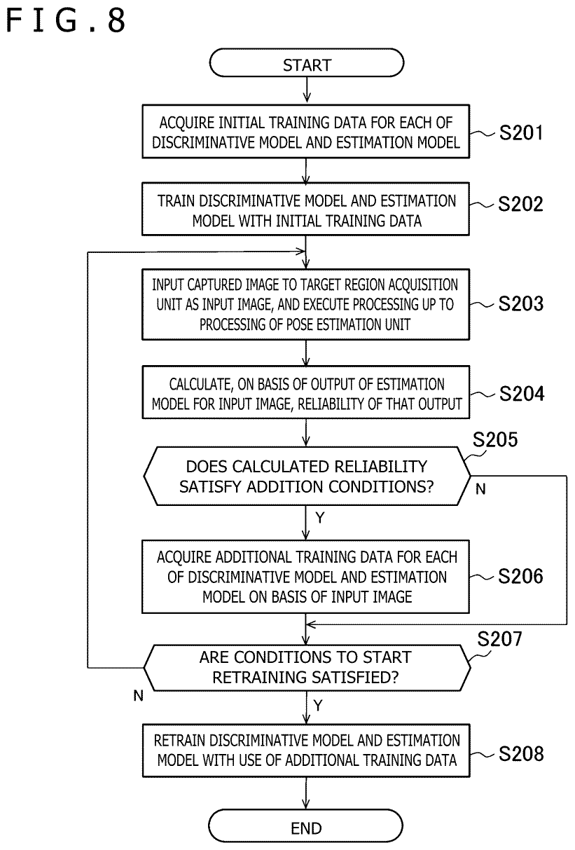

Next, the outline of the training of the discriminative model 24 and the estimation model 26 is described. FIG. 8 is a flow diagram schematically illustrating the training of the discriminative model 24 and the estimation model 26.

First, the discriminative training data generation unit 34 acquires initial training data for the discriminative model 24, and the estimation training data generation unit 37 acquires initial training data for the estimation model 26 (S201).

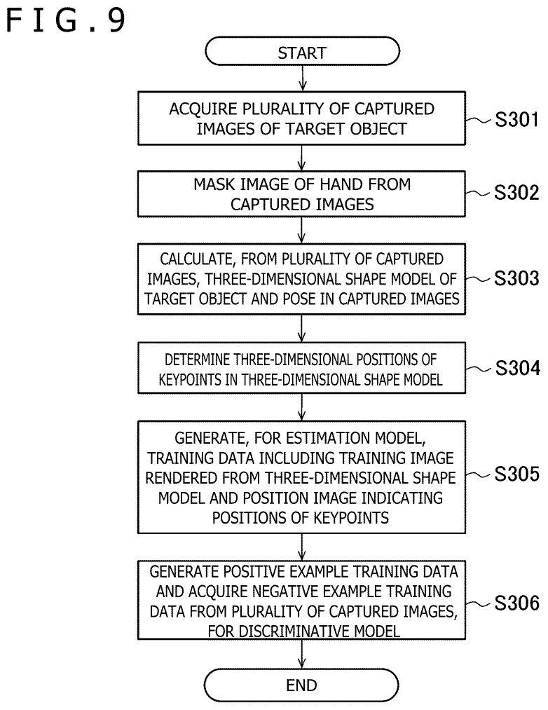

The processing in Step S201 is described in further detail. FIG. 9 is a flow diagram illustrating an example of the processing of generating the initial training data.

The captured image acquisition unit 33 acquires a plurality of captured images in which the target object 51 is captured (S301).

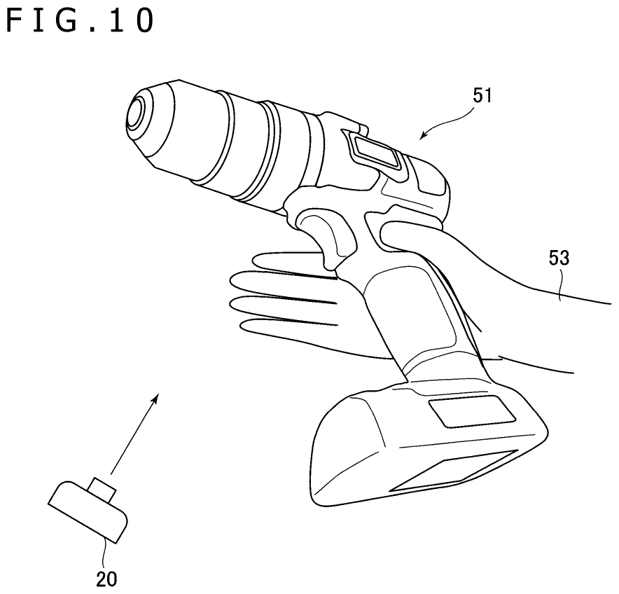

FIG. 10 is a view illustrating how the target object 51 is captured. The target object 51 is held by, for example, a hand 53 and captured by the image capturing unit 20. In the present embodiment, it is desirable to capture the target object 51 from various directions. Thus, the image capturing unit 20 changes the capturing direction of the target object 51 while capturing images periodically like moving image capturing. For example, the pose of the target object 51 may be changed with the hand 53 to change the capturing direction of the target object 51. Further, the target object 51 may be placed on an AR (Augmented Reality) marker, and the image capturing unit 20 may be moved to change the capturing direction. The acquisition interval of captured images used in the processing described below may be wider than the capturing interval of moving images.

When the captured images are acquired, the captured image acquisition unit 33 masks the image of the hand 53 from those captured images (S302). The image of the hand 53 may be masked by a well-known method. For example, the captured image acquisition unit 33 may mask the image of the hand 53 by detecting regions of skin color included in the captured images.

Then, the shape model acquisition unit 36 calculates, from the plurality of captured images, a three-dimensional shape model of the target object 51 and a pose in each captured image (S303). This processing may be performed by the above-mentioned well-known method also used for software for implementing what is called SfM and Visual SLAM. The shape model acquisition unit 36 may calculate the pose of the target object 51 on the basis of a calculation logic for the capturing direction of the camera by this method.

When the three-dimensional shape model of the target object 51 is calculated, the shape model acquisition unit 36 determines the three-dimensional positions of a plurality of keypoints used for estimating the pose of that three-dimensional shape model (S304). The shape model acquisition unit 36 may determine the three-dimensional positions of the plurality of keypoints by a well-known Farthest Point algorithm, for example.

When the three-dimensional positions of the keypoints are calculated, the estimation training data generation unit 37 generates, for the estimation model 26, training data including a plurality of training images and a plurality of position images (S305). More specifically, the estimation training data generation unit 37 generates a plurality of training images rendered from the three-dimensional shape model and generates position images indicating the positions of the keypoints in the plurality of training images. The plurality of training images are rendered images of the target object 51 viewed from a plurality of directions different from each other, and the position images are generated for each combination of the training images and keypoints.

The estimation training data generation unit 37 virtually projects the positions of the keypoints onto the rendered training images and generates position images on the basis of the relative positions of those projected positions of the keypoints and each point in the images. The training data used for the training of the estimation model 26 includes training images and position images.

The training images included in the initial training data are rendered images. This is because, while it is difficult to acquire captured images captured from various capturing directions in a short period of time, images viewed from various capturing directions can easily be generated with use of a three-dimensional shape model. Note that the initial training data may include training images that are photographed images.

The discriminative training data generation unit 34 generates positive example training data from the plurality of captured images acquired by the captured image acquisition unit 33, more specifically, from images including the target object 51, and acquires negative example training data from images not including the target object and stored in the storage unit 12, for example (S306). The positive example training data and the negative example training data are pieces of training data for the discriminative model 24.

The discriminative training data generation unit 34 may perform processing depending on images input to the discriminative model 24, such as cutout of regions including the target object 51, size normalization, background masking, or feature amount extraction, thereby generating positive example training data from the captured images. The discriminative training data generation unit 34 inputs negative example sample images stored in the storage unit 12 in advance to the feature extraction unit 23 and acquires output feature amount data, thereby generating a plurality of pieces of negative example training data. The feature amounts are extracted by the same processing as the feature extraction unit 23 included in the discriminative model 24. The negative example sample images may be, for example, images captured by the image capturing unit 20 in advance, images collected from the Web, or images of positive examples of other objects. The negative example training data may be generated and stored in the storage unit 12 in advance.

Note that the discriminative model 24 is not limited to the one described so far and may be one configured to directly determine whether the target object 51 is present from the images.

When the pieces of initial training data for the discriminative model 24 and the estimation model 26 are acquired, the discriminative learning unit 35 trains the discriminative model 24 with the initial training data for the discriminative model, and the estimation learning unit 38 trains the estimation model 26 with the initial training data for the estimation model (S202). The discriminative model 24 may be, for example, an SVM, and the discriminative learning unit 35 may train the SVM with the positive example training data and the negative example training data.

When the discriminative model 24 and the estimation model 26 are trained, in S203 to S207, the information processing system acquires, while executing the processing of what is called inference with use of those models, additional training data for each of the discriminative model 24 and the estimation model 26 depending on reliability.

In S203, the information processing system inputs the captured images to the target region acquisition unit 21 as input images, and the target region acquisition unit 21 and the pose estimation unit 25 execute the processing of extracting the target region 55 and estimating the pose of the target object 51 included in the target region 55. The processing in S203 corresponds to the processing from S101 to S107 of FIG. 6.

Next, the reliability acquisition unit 39 calculates, on the basis of the output of the estimation model 26 included in the pose estimation unit 25, the reliability of that output (S204). This processing corresponds to the processing in S108 of FIG. 6.

More specifically, the reliability acquisition unit 39 calculates the reliability by the following procedure, for example. The reliability acquisition unit 39 selects a plurality of groups, each including two points, from the position image output by the estimation model 26. For each group, the reliability acquisition unit 39 calculates, on the basis of the directions of the keypoints indicated by each point included in the group, the candidate positions of the keypoints. The candidate position corresponds to the intersection point of the straight line extending from a certain point in the direction indicated by the point and the straight line extending from the other point in the direction indicated by the point. When the reliability for each group is calculated, the reliability acquisition unit 39 calculates a value indicating the variation of the candidate positions as the reliability. The reliability acquisition unit 39 may take the average value of the distances from the center of gravity of the candidate positions as the reliability, or may calculate the standard deviation in any direction of the candidate positions as the reliability, for example.

The reliability acquisition unit 39 may calculate the reliability from values other than those indicating the variation of the candidate positions. For example, the reliability acquisition unit 39 may calculate the reliability on the basis of information indicating the difference between the output of the estimation model 26 when such an input image as the image of the target region is input to the estimation model 26 and the output of the estimation model 26 when a processed image obtained by processing the input image by predetermined processing is input to the estimation model 26.

More specifically, first, the reliability acquisition unit 39 executes predetermined processing (Augmentation) on the image of the target region. This processing may be either a brightness change or noise addition, for example. Next, the reliability acquisition unit 39 inputs the processed image to the estimation model 26 and acquires a position image output from the estimation model 26. Then, the reliability acquisition unit 39 calculates a value indicating the difference between the position image output for the initial image of the target region (initial output) and the position image output for the processed image as the reliability. This value may be a statistic of the differences in value at each point between the initial output and the output for the processed image, or may include the distances between the positions of the keypoints calculated from the initial output and the positions of the keypoints calculated from the output for the processed image. Further, instead of the output for the initial image of the target region, the output when an image obtained by performing processing which is different from the predetermined processing on the image of the target region is input to the estimation model 26 may be used. Note that the method of the processing (Augmentation) performed here may be different from that of processing by the estimation training data generation unit 37 described later. Due to the difference in methods, when the estimation model 26 trained with additional training data is used to calculate reliability, the resulting accuracy of the reliability is reduced.

The reliability acquisition unit 39 may output the final reliability by combining the reliability (element) calculated from the value indicating the variation of the candidate positions and the value indicating the difference between the initial output and the output for the processed image. The reliability acquisition unit 39 may output a value obtained through weighted addition of the former and the latter as the reliability, for example.

When the reliability is calculated, the reliability acquisition unit 39 determines whether the calculated reliability satisfies addition conditions for adding training data (S205). The addition conditions may include, for example, that the value of the variation calculated as the reliability is smaller than a threshold.

In a case where the reliability satisfies the addition conditions (Y in S205), the discriminative training data generation unit 34 and the estimation training data generation unit 37 generate pieces of additional training data to be added to the training data for the discriminative model 24 and the estimation model 26, respectively (S206). S205 and S206 correspond to the processing in S109 of FIG. 6.

More specifically, the discriminative training data generation unit 34 determines the image corresponding to the target region 55 (for example, the image of the corresponding candidate region 56), which is the source of that position image, as a positive example image, and adds data on the positive example image to the training data for the discriminative model. The discriminative training data generation unit 34 may perform, on the image determined as a positive example image, processing depending on images input to the discriminative model 24, such as feature amount extraction, thereby generating positive example training data from the captured images.

Further, the estimation training data generation unit 37 generates a set of a first additional image and a second additional image on the basis of the image of the target region, which is the source of that position image, and adds the set to the additional training data for the estimation model.

More specifically, the estimation training data generation unit 37 executes first processing (Augmentation) on the image of the target region and acquires the processed image as a first additional image. Further, the estimation training data generation unit 37 executes second processing (Augmentation) on the image of the target region and acquires the processed image as a second additional image. The first processing and the second processing are different from each other and may each include, for example, either a brightness change or noise addition. Further, one of the first processing and the second processing may not involve substantial processing. The method of training the estimation model with use of the set of the first additional image and the second additional image (Consistency loss) is described later.

Note that the estimation training data generation unit 37 may add a set of the image of the target region, which is the source of the position image, and ground truth data indicating the pose calculated by the pose estimation unit 25 for the image, to the additional training data. The estimation model 26 may be trained with that data by the same method as the initial training.

In the present embodiment, part of the input data at the time of inference with use of the trained machine learning model is added to the training data. Meanwhile, in general, input data at the time of inference is not added to training data. This is because, for example, in a case where the output for the input data is incorrect, there is a risk that adding the input data degrades the quality of the training data. In the present embodiment, the reliability of the output of the machine learning model is calculated, and whether or not to add data to the training data is filtered with use of that reliability. This ensures the quality of the data to be added, thereby making it possible to improve the accuracy of the machine learning model while reducing the labor of generating training data.

Here, the reliability calculated in the present embodiment can be considered as the reliability of the discriminative model 24 and the estimation model 26. From the perspective of the reliability of the output of the discriminative model 24, it can be said that the reliability indicating whether a position image output by the estimation model 26, which is on the latter stage of the discriminative model 24, is in a state where keypoints can accurately be obtained is obtained. Whether the processing including the machine learning model on the latter stage can be performed appropriately is used as an indicator of reliability in this way, thereby allowing for simple and effective reliability calculation. Further, from the perspective of the reliability of the output of the estimation model 26, it can be said that, whether the processing on the latter stage to obtain keypoints from a position image, which is an output, can be performed appropriately is used as an indicator of reliability.

When the additional training data is acquired, S203 and the processing after S203 are repeatedly executed until conditions to start retraining are satisfied (N in S207). The conditions to start retraining may include that the number of pieces of acquired additional training data reaches a threshold, or the operation to end what is generally called iterative estimation processing is input.

When the conditions to start retraining are satisfied (Y in S207), the discriminative learning unit 35 and the estimation learning unit 38 retrain the discriminative model 24 and the estimation model 26, respectively (S208).

Here, retraining refers to training a machine learning model with use of training data including additional training data. The machine learning model (the discriminative model 24 or the estimation model 26) to be trained may be a different instance from the discriminative model 24 or the estimation model 26 that is a machine learning model executing inference, or may be the same instance as the machine learning model executing inference. In the former case, the instance of the discriminative model 24 or the estimation model 26 used for inference may be switched after training has been completed. Further, instead of instance switching, the newly learned parameters of the machine learning model may be copied to the instance of the discriminative model 24 or the estimation model 26 used for inference.

Regarding the discriminative model 24, the discriminative learning unit 35 may add the additional training data to the initial training data and train the discriminative model 24 with the training data after the addition. Further, the training data used for the training of the discriminative model 24 may be all of the initial training data and the additional training data, or part of them. Part of the training data used for the training of the discriminative model 24 may be, for example, one selected such that the number of pieces of training data is equal to or less than the maximum value of the total number of samples, or may be one in which samples determined to be of low quality by some method are excluded.

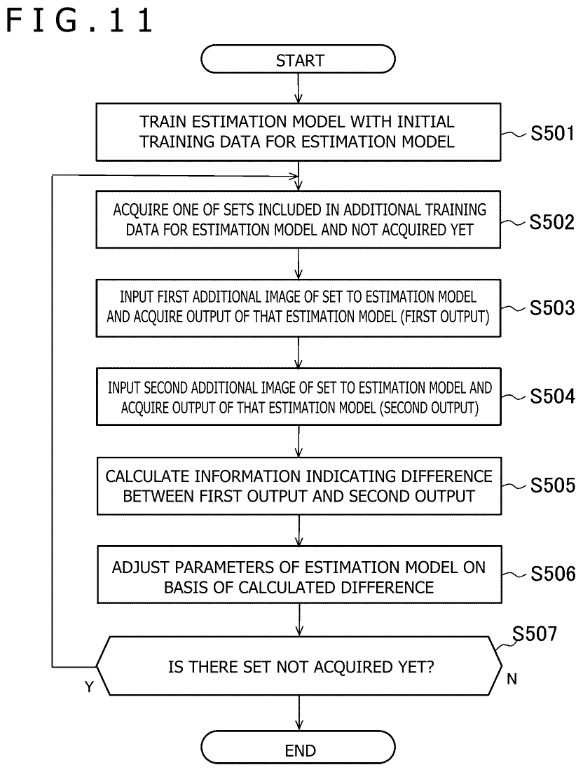

Meanwhile, the method of retraining the estimation model 26 with the additional training data on the first additional image and the second additional image is different. FIG. 11 is a flow diagram illustrating an example of the processing of retraining the estimation model, and in the retraining, the processing illustrated in FIG. 11 is executed a plurality of times repeatedly.

First, the estimation learning unit 38 trains the estimation model 26 with use of initial training data for the estimation model 26 (S501). This training uses a similar method to the training of the estimation model 26 in Step S202. More specifically, the estimation learning unit 38 adjusts the parameters of the estimation model 26 with the difference (L1 loss) between a position image output by the estimation model 26 and ground truth data as a teacher signal.

Next, the estimation learning unit 38 acquires one of the sets included in the additional training data for the estimation model 26 and not acquired yet (S502). The estimation learning unit 38 inputs a first additional image included in the set to the estimation model 26 and acquires the output of the estimation model 26 (first output) (S503). Further, the estimation learning unit 38 inputs a second additional image included in the set to the estimation model 26 and acquires the output of the estimation model 26 (second output) (S504).

The estimation learning unit 38 calculates information indicating the difference between the first output and the second output (Consistency loss) (S505) and adjusts the parameters of the estimation model 26 on the basis of that information indicating the difference (S506). The information indicating the difference may be a statistic (for example, average) of the differences in value at each point of the first output and the second output.

Here, regarding the additional training data, since training depending on the difference between the first output and the second output is performed, when training is performed mainly by this method, there is a risk that the parameters of the estimation model 26 converge such that the same position image is output regardless of input, for example. To avoid such a situation, it is desirable to keep the ratio of the number of pieces of additional training data to the total number of pieces of training data including the initial training data within a predetermined value (for example, 20%).

Retraining is performed with use of the additional training data, depending on whether two images based on the same image match or not, thereby making it possible to perform training also with use of training data without ground truth labels, leading to an improvement in accuracy.

In the present embodiment, the image to be input to the estimation model 26 is limited, by the processing of the target region acquisition unit 21, to, among captured images, an image that is the image of a region in which the target object 51 is present and that is highly likely to have the target object 51 at the center. Further, the estimation model 26 of the pose estimation unit 25 is trained with training data generated by the three-dimensional shape model. Meanwhile, the discriminative model 24 of the target region acquisition unit 21 is trained on the basis of images in which the target object 51 is captured.

The image to be input to the estimation model 26 is limited appropriately, thereby improving the accuracy of the output of the estimation model 26, and the accuracy of the estimated pose of the target object 51. Moreover, the discriminative model 24 is trained on the basis of not images based on the three-dimensional shape model but captured images, thereby making it possible to select the target region 55 more accurately, leading to an improvement in the accuracy of the estimation model 26.

In the present embodiment, captured images for generating a three-dimensional shape model for training the estimation model 26 of the pose estimation unit 25 are also used when training the discriminative model 24. Accordingly, the labor required to capture the target object 51 is reduced, and the time taken for training the estimation model 26 and the discriminative model 24 is reduced.

Note that the present invention is not limited to the embodiment described above.

For example, the discriminative model 24 may be any kernel SVM. Further, the discriminative model 24 may be a discriminator using methods such as the K-nearest neighbors, logistic regression, AdaBoost, or other boosting methods. Further, the discriminative model 24 may be implemented by neural networks, Naive Bayes classifiers, random forests, or decision trees.

The output of the estimation model 26 may be a position image such as a heat map indicating the positions of keypoints. In this case, for example, the reliability acquisition unit 39 may obtain the number of peaks in the position image output by the estimation model 26 as the reliability. In a case where the number of these peaks is smaller than a threshold, the input data may be added to the training data.

Further, the specific character strings and numerical values described above, as well as the specific character strings and numerical values in the figures, are examples. The present invention is not limited to these character strings and numerical values, and the character strings and the numerical values may be modified as needed.

1. An information processing system comprising:
a machine learning model trained with training data;
reliability output means outputting, on a basis of an output of the machine learning model when input data is received as an input, reliability of the output for the input data;
generation means generating new training data on a basis of the input data in a case where the reliability satisfies a predetermined condition; and
learning control means training the machine learning model with the new training data.

2. The information processing system according to claim 1, further comprising:
a trained estimation model configured to output an estimation result on a basis of the output of the machine learning model,
wherein the reliability output means outputs the reliability of the output of the machine learning model for the input data on a basis of an output of the estimation model.

3. The information processing system according to claim 2, wherein
the input data includes an image in which a target object is captured,
the estimation model outputs an image indicating a keypoint for pose estimation of the target object on a basis of the output of the machine learning model, and
the reliability output means outputs the reliability on a basis of the image.

4. The information processing system according to claim 3, wherein
the estimation model outputs an image in which each point indicates a positional relation with the keypoint, and
the reliability output means outputs the reliability on a basis of a variation of candidates for positions of a plurality of the keypoints each generated from points different from each other included in the image output by the estimation model.

5. The information processing system according to claim 2, wherein the reliability output means outputs the reliability on a basis of information indicating a difference between the output of the estimation model when an input image is input to the estimation model and the output of the estimation model when a processed image obtained by processing the input image by predetermined processing is input to the estimation model.

6. The information processing system according to claim 3, wherein the machine learning model outputs information indicating whether the input data includes the target object or not.

7. The information processing system according to claim 2, wherein
the estimation model is trained with estimation training data,
the generation means generates new estimation training data on a basis of the input data in a case where the reliability satisfies the predetermined condition, and
the learning control means trains the machine learning model with the new training data.

8. The information processing system according to claim 1, wherein
the input data includes an image in which a target object is captured,
the machine learning model outputs an image indicating a keypoint for pose estimation of the target object on a basis of the input data, and
the reliability output means outputs the reliability on a basis of the image.

9. The information processing system according to claim 8, wherein the training data includes a plurality of learning images rendered from a three-dimensional shape model and ground truth images each serving as ground truth data for a corresponding one of the learning images.

10. The information processing system according to claim 2, wherein
the generation means generates new training data including a first additional image obtained by processing the input data by first processing and a second additional image obtained by processing the input data by second processing different from the first processing, and
the learning control means trains the machine learning model on a basis of a difference between an output when the first additional image is input to the machine learning model and an output when the second additional image is added to the machine learning model.

11. An information processing method comprising:
outputting, on a basis of an output of a machine learning model being trained with training data when input data is received as an input to the machine learning model, reliability of the output for the input data;
generating new training data on a basis of the input data in a case where the reliability satisfies a predetermined condition; and
training the machine learning model with the new training data.

12. A non-transitory, computer readable storage medium containing a program for causing a computer to execute a method by carrying out actions, comprising:
outputting, on a basis of an output of a machine learning model being trained with training data when input data is received as an input to the machine learning model, reliability of the output for the input data;
generating new training data on a basis of the input data in a case where the reliability satisfies a predetermined condition; and
training the machine learning model with the new training data.
